(19) United States
(12) Patent Application Publication
(10) Pub. No.: US 2010/0054123 A1
(43) Pub. Date: Mar. 4, 2010

(54) METHOD AND DEVICE FOR HIGN UTILIZATION AND EFFICIENT FLOW CONTROL OVER NETWORKS WITH LONG TRANSMISSION LATENCY

(76) Inventor: Liu Yong, Singapore (SG)

Correspondence Address: Liu Yong, Blk 766, #05-297, Choa Chu Kang North 5,, Singapore, 680766, SG

(21) Appl. No.: 12/202,226

(22) Filed: Aug. 30, 2008

(51) Int. Cl. H04L 12/56

(52) U.S. Cl. 370/230

(57) ABSTRACT

The present invention is to provide a method and device which can determine current available bandwidth for each Transport Control Protocol (TCP) connection and adjust window size dynamically according to the available bandwidth to achieve high network utilization and efficient flow control in the same time without the need to buffer any received TCP packets, which can work with and without support of large window option. The device classifies incoming traffic into several groups (public and private), monitors and allocates the available bandwidth for each group. To enable flow control, the device also records the initial window size value for each connection and compares it with the original window size value for a newly received TCP packet. If the original window size value received from TCP receivers changes, the device varies the modified window size accordingly to enable efficient flow control in the same device as well.

### FIELD OF THE INVENTION

The present invention relates in general to electronic data communication systems, and in particular to a method and device for network acceleration over networks with long transmission latency. Still more particularly, the present invention relates to a method and system for high utilization of available bandwidth and efficient flow control over networks with long transmission latency.

### BACKGROUND OF THE INVENTION

With the rapid development of economic globalization and information technology, more and more enterprises from Fortune 1000s to small and medium enterprises need efficient data communications among their branches which are located around the world. These enterprises need to lease certain network bandwidth over wide area networks (WANs) which usually have long transmission latency since they are normally located in different places around the world. However the rapid proliferation of network traffic makes the WAN to be the bottleneck in efficient application delivery. Even though those WAN users want to improve their networking performance by leasing more bandwidth for their WANs from Telcos, WANs with improved bandwidth still cannot be well utilized due to some inherent problems of current TCP standard over networks with long transmission latency.

The reason why current TCP standard does not work well for networks with long transmission latency is described as follows. In current TCP standard, once a TCP connection is established between a TCP source and a TCP destination. The TCP destination will allocate a fixed size buffer to the connection and advertise the buffer size (advertised window) to the TCP source as an initial window size. Subsequently, the TCP source acknowledges received data from the TCP source by ACK packets. In the packet header of each ACK packet, the TCP destination indicates the available space in the allocated buffer. The available space in the buffer depends on the rate the TCP destination drains data from the buffer. TCP source determines data sending rate according to an advertised TCP window size received from a TCP receiver, which determine the throughput for the TCP connection. The TCP source is not allowed to send more data packets than the advertised window size without acknowledgment to avoid overflowing of the TCP source. This mechanism does not take into consideration the available bandwidth between the TCP source and destination. Since it takes a round trip time (RTT) for each ACK packet reach TCP source, for networks with long transmission time, i.e. large RTT, the maximum TCP throughput is very slow such that the network bandwidth is seriously under utilized even there are plenty of network bandwidth available.

There are some related works. A large window option is included in recently TCP standard to achieve high TCP throughput for high speed networks. However, the advertised window size still does not take into consideration the available network bandwidth. In addition, to support the large window scale option, all computers using TCP need to be reconfigured, which is time and labor consuming. This method is still rarely used since manual turning is required for appropriate configuration under different network conditions. A recent work (U.S. Pat. No. 7,133,361B2) proposes a method to add the large window scale option in a gateway between a TCP source and a TCP destination. The gateway also stores each received packet from the TCP source into a buffer. According the occupancy of the buffer, the gateway modifies the window size. However, the method still requires the large scale window option support form the TCP source. In addition, all packets received from all TCP sources need to be stored in the gateway, which needs a lot of random access memory (RAM) for the storage and also introduces a significant processing overhead for the gateway. The scalability to support high bandwidth transmission and large number of users will be prohibitive for this method. In addition, this method still does not take into consideration the current bandwidth available for determination of the modified window size to achieve high utilization of available network bandwidth.

In light of foregoing, it is desirable have a method and device which can determine current available bandwidth for each TCP connection and adjust window size dynamically according the available bandwidth to achieve high network utilization. It is also desirable to have an automatic method and device which are transparent to end users for TCP acceleration for networks with long transmission latency. It is also desirable to have a method and device to achieve high bandwidth utilization and efficient flow control in the same time. It is also desirable to have a method and device which are scalable to support high speed bandwidth and large number of users without the need to buffer any received TCP packets. It is further desirable to have a method and device which can work with and without support of large window option.

### SUMMARY OF THE INVENTION

It is therefore one object of the present invention to provide a method and device which can determine current available bandwidth for each TCP connection and adjust window size dynamically according the available bandwidth to achieve high network utilization.

It is another object of the present invention to have a method and device to achieve high bandwidth utilization and efficient flow control in the same time without the need to buffer any received TCP packets and can work with and without support of large window option.

A device using the said method runs as an accelerator at the edge of a network. The accelerator adjusts window size value for TCP packets according to available network bandwidth, network round trip time (RTT) and flow control information received from remote TCP destinations. The said accelerator classifies incoming traffic into several groups according to their destinations in accordance with the preferred embodiment of the invention. The traffic flows that come from a same remote branch will be considered as a group, which is called as a private group. For those traffic flows that does not come from any remote branch are considered a special group, which is called public group. In each group, there are two subgroups, namely TCP traffic and non-TCP traffic. The present invention only adjusts window size for TCP packets for each group. For each group, the accelerator monitors the available bandwidth for that group in accordance with the preferred embodiment of the invention, which is the difference between the allocated bandwidth and measured network bandwidth usage by non-TCP traffic in the same group. For each private group, the allocated bandwidth is the leased bandwidth from Telcos between the local branch and the corresponding remote branch. For the public group, the allocated bandwidth is the difference between the link capacity and the aggregation of the allocated bandwidth for all private groups. The accelerator also monitors the round trip time (RTT) for each TCP connection in accordance with the preferred embodiment of the invention. With the measurement result on RTT, the accelerator converts the available bandwidth for each connection to corresponding window size value such that the available bandwidth can be almost fully utilized. When there is more available bandwidth, the window size value for each incoming TCP packet increases proportionally. To enable flow control at the same time, the accelerator also records the initial window size value for each connection during the initialization state of that TCP connection and compares it with the original window size value for a newly received TCP packet. If the original window size value received from TCP receivers decrease, the accelerator decreases the modified window size accordingly to enable flow control in the accelerator. Lastly, a new window size value is determined and applied to each received TCP packet by considering all above factors to achieve high network utilization and efficient flow control in the same time.

### BRIEF DESCRIPTION OF THE DRAWINGS

FIG. 1 depicts a communication system utilizing an accelerator to accelerate TCP transmission in accordance with the preferred embodiment of the inventions;

FIG. 2 depicts the architecture of the accelerator including traffic classifier module, RTT measurement module, bandwidth measurement module, TCP connection number measurement module, window size calculation module and window size modification module in accordance with the preferred embodiment of the invention;

FIG. 3 depicts a typical header format for a TCP packet utilized within the preferred embodiment of the invention;

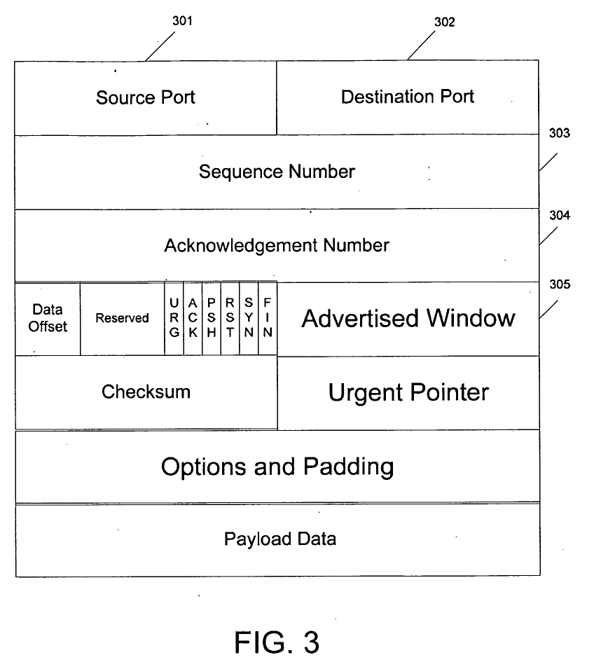

FIG. 4 depicts an implementation of the present invention using a computer system in accordance to the preferred embodiment of the present invention.

### DETAILED DESCRIPTION OF THE PREFERRED EMBODIMENT

The present invention implements a scheme to improve TCP performance for networks with long transmission latency. The invention is implemented as an accelerator which is describe in detail as following to provide a through understanding of the present invention. The accelerator measures networks usage and various network parameters. Based on these measurements, the accelerator calculates available bandwidth for each TCP connection and set window size accordingly to achieve high network utilization and efficient flow control in the same time.

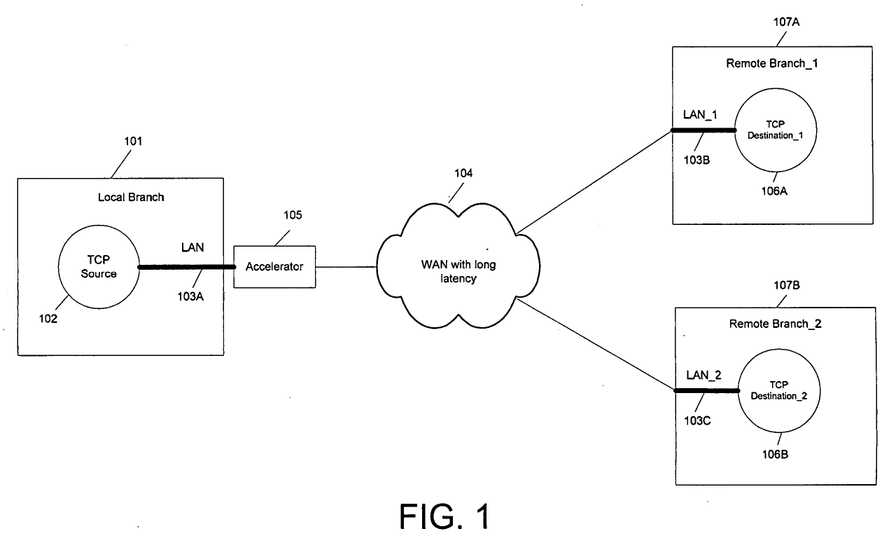

As shown in FIG. 1, the accelerator 105 is located at the edge of a local area network (LAN) 103A for a local branch 101. The accelerator 105 is responsible to accelerate all TCP connections with TCP sources inside the LAN 103A. The accelerator 105 can either be a stand-along device or a software or hardware module working together with other networking devices including routers to speed up TCP connections.

If TCP source 102 wants to send some data to TCP destination_{—}1 106A, TCP source 102 sends a request packet to establish connection with TCP destination_{—}1 106A. Upon receiving the request packet from TCP source 102, TCP destination_{—}1 106A sends an acknowledgement (ACK) packet to TCP source 102. The ACK packet includes the advertisement receive window size 305 which is the buffer size allocated by TCP destination_{—}1 106A for the new connection. Upon receiving the ACK packet, TCP source 102 also sends an acknowledgment packet to TCP destination_{—}1 106A and start sending data according to the advertisement window from TCP destination_{—}1 106A. For each received data received from TCP source 102, TCP destination_{—}1 106A sends ACK packet to TCP source 102. The data that have been sent but have not been acknowledged is called outstanding data. For TCP source 102, there is also another window called congestion window which limit the transmission rate for TCP source 102. According to current TCP standard, the outstanding data at TCP source 102 should be less data than the minimum of congestion window and advertisement window. Thus, TCP source 102 has to wait until some of its outstanding data to be acknowledged by TCP destination_{—}1 106A before it can start sending subsequent data. Since it takes a round trip time (RTT) for each ACK packet to traverse WAN 104 with long latency, the throughput between TCP source 102 and TCP destination_{—}1 106A is limited by following equations:

TCP Throughput=Advertised Window Size/RTT

In current TCP standard, the advertisement window size is the available space in the buffer allocated by TCP destination_{—}1 106A for the TCP connection. The available space is the difference between the allocated buffer size and occupancy of packets which have not been processed by TCP applications yet. Therefore, the available network bandwidth is not taken into consideration for calculation of the advertisement window size. For networks with large RTT, TCP throughput is seriously low, thus leading to very low network utilization even though a lot of bandwidth is available in the WAN 104. In order to achieve high network bandwidth utilization, the present invention implements a method to dynamically set the advertisement window size according to the measured available network bandwidth for each TCP connection. This could be done by each TCP destination. However, it is impractical and also not scalable since each communication devices running TCP needs to be modified accordingly. In viewing of this, the present invention implements a method utilizing an accelerator 105 at the edge of a network to measure available bandwidth and modify advertised window 305 accordingly to achieve network acceleration without any kinds of involvement from end users.

In present invention, all data packets received by the accelerator 105 from LAN 103A are considered as outgoing packets. All packets received by the accelerator are considered as incoming packets. The accelerator 105 intercepts all outgoing and incoming data packets. For each outgoing packet, the accelerator 105 extracts information from its packet header for measurement purpose and then forward the packets without any modifications. For each incoming packet, the accelerator 105 extracts information from its packet header for measurement purpose. For each incoming acknowledgement (ACK) packet, the accelerator 105 calculates the available bandwidth for the TCP connection to which the ACK packet belongs. Then the accelerator 105 calculates a new window size according to the available bandwidth and resets the window size value 305 in the packet header of the incoming acknowledgement packet. After that, TCP source 102 will transmit data packets according to the new window size value. The accelerator 105 can track the network status and dynamically determine the available bandwidth for each connection to achieve high network bandwidth utilization.

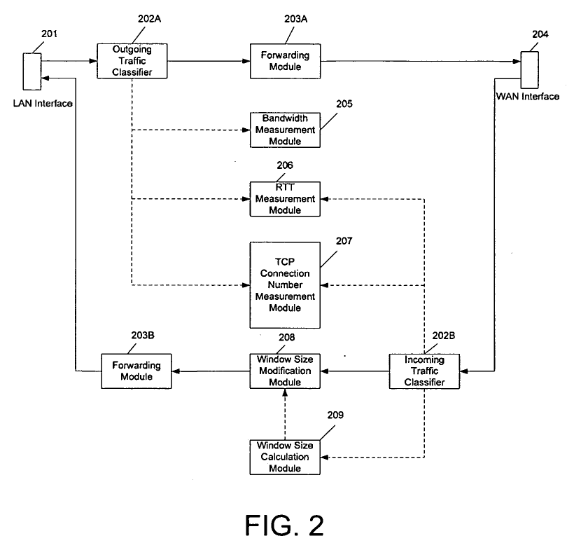

FIG. 2 depicts the architecture of the accelerator including outgoing traffic classifier module 202A, bandwidth measurement module 205, RTT measurement module 206, TCP connection number measurement module 207, incoming traffic classifier module 202B, window size calculation module 209 and window size modification module 208 in accordance with the preferred embodiment of the invention. For each outgoing packet received from LAN interface 201, the accelerator extracts information from its header and forwards it using forward module 203A without any modifications. For each incoming TCP packet received from WAN interface 204, the accelerator extracts information from its header, calculates a new window size value, applies it to the packet, and forwards the modified packet using forwarding module 203B to LAN interface 201. In FIG. 2, solid lines denote for the transmission of packet and lines of dashes denote for the transmission of information. The functionalities of each module in accordance with the preferred embodiment of the invention are described as following.

### 1) Outgoing Traffic Classifier Module 202A

Outgoing traffic classifier module 202A classifies outgoing packets to several groups according to their destination IP addresses. For all packets with the destinations within a same sub-network (remote branch) are considered as a group, which is called a private group in the embodiment of the present invention. For example, a company or organization may have N remote branches around the world. There will be N private groups in this case. In the scenario of FIG. 1, there are two private groups. For those packets with destinations outside any of these sub-networks (remote braches) are considered as a special group, which is called a public group in the embodiment of the present invention. In each group, there are two subgroups, namely TCP traffic and non-TCP traffic.

### 2) Bandwidth Measurement Module 205

Bandwidth measurement module 205 measures bandwidth usage of outgoing non-TCP traffic for each traffic group. This module records the amount (byte) of outgoing non-TCP traffic every minute for each group including private group and public group. The bandwidth usage can be obtained by a moving average method to avoid measurement fluctuation. The bandwidth usage measurement module 205 also has the record on the bandwidth allocated for each private group, which is the leased bandwidth from Telcos for each remote branch. For each private group, with the measured bandwidth usage for non-TCP traffic and allocated bandwidth for each private group, the available bandwidth for each private group is obtained by the difference between the measured bandwidth usage for non-TCP traffic and the allocated bandwidth for each private group. For the public group, the allocated bandwidth is the left-over bandwidth which is the difference between the outgoing link capacity and the sum of all other allocated bandwidth for each private group. Then, for the public group, the available bandwidth is obtained by the difference between the measured bandwidth usage for non-TCP traffic in the public group and the left-over bandwidth for the public group.

### 3) RTT Measurement Module 206

RTT measurement module 206 measures the round trip time for each TCP connection between TCP source and TCP destination. Since the distance from TCP source 102 to the accelerator 105 is very short (they are located in a same LAN 103A) and they are usually connected by a high speed LAN 103A, the latency between TCP source 102 and the accelerator 105 is negligible. In this case, the RTT for each TCP connection can be approximated by the RTT between TCP destinations. For this, the accelerator records arrival time and sequence number for outgoing TCP packets which are randomly chosen for each TCP connection. For each record, the accelerator maintains the source IP address, destination IP address, sequence number 303, source port number 301 and destination port number 302 for each chosen outgoing TCP packet. When ACK packets return, their source IP address, destination IP address, acknowledgement number 304, source port number 301 and destination port number 302 are used to find the corresponding records. Then, the RTT for each TCP connection is obtained by the difference between the arrival time and the return time. A moving average method can be used to obtain the smoothed RTT to avoid measurement fluctuation.

### 4) TCP Connection Number Measurement Module 207

TCP connection number measurement module 207 measures the number of active TCP connections for each group. As described earlier, to establish a TCP connection between TCP source and destination, one side sends a request (SYN) packet to the other side. The other side then sends an acknowledgement (SYN_ACK) packet for confirmation. To release a TCP connection, one side sends a finish (FIN) packet to the other side and the other side sends an acknowledgement (FIN_ACK) for confirmation. The accelerator maintains a counter for number of active TCP connection within each group. The counter increases by 1 when there is a newly established TCP connection in that group. For a newly established TCP connection, this module also records its initial window size 305 from SYN_ACK packet which is the allocated buffer size by TCP destination. The counter decreases by 1 when an established TCP connection in that group is released.

### 5) Incoming Traffic Classifier Module 202B

Incoming traffic classifier module 202B classifies incoming packets to several groups according to their source IP addresses. Same as the functionality of the outgoing traffic classifier module, for all packets with the source IP addresses within a same sub-network (remote branch) are considered as a group, which is called a private group in the embodiment of the present invention. For example, a company or organization may have N remote branches around the world. There will be N private groups in this case. For those packets with source IP addresses outside any of these sub-networks (remote braches) are considered as a special group, which is called a public group in the embodiment of the present invention. In each group, there are two subgroups, namely TCP traffic and non-TCP traffic.

### 6) Window Size Calculation Module 209

Window size calculation module 209 calculates new window size as following. For a newly intercepted incoming TCP packet, this module searches for its corresponding connection and group according to its source IP address, destination IP address, source port number 301 and destination port number 302. Then, based on the measurement results on the available bandwidth measured by 205 for the group which the TCP packet belongs to, RTT measured by 206 for the TCP connection which the TCP packet belongs to and number of TCP connections in that group measured by 207, recorded initial window size value for that connection, and the original window size 305 for the newly intercepted incoming, the new window size value is obtained as follows in accordance with the preferred embodiment of the invention.

New Window Size=(Original Window Size/Initial Window Size for the Connection)*(Available Bandwidth for the Group*RTT for the Connection)/Number of TCP Connections for the Group. Eq.(1)

According to Eq. (1), the new window size is proportional to the available bandwidth for the group and round trip time for the connection such that the available bandwidth for the group can be almost fully utilized. Eq. (1) also converts the available bandwidth to corresponding wind size by multiplying the measured RTT for the connection. The new window size is inverse proportional to the number of TCP connections in that group such that the available bandwidth can be fairly allocated to each TCP connection. In the case when network users want to allocate some bandwidth for other non-TCP applications, the new window size can be reduced by multiplying a factor which is less than one. The network users can control the network utilization by control the factor.

In addition, an important part in Eq (1) is that the new window size is proportional to the original window size 305 for the packet and inverse proportional to the initial window size for the connection. The purpose is to enable flow control from TCP destination to TCP source while maintaining high utilization of available network bandwidth utilization. The original window size 305 is set by a TCP destination (106A or 106B). If the original window size 305 equals to the initial window size of this connection, all available bandwidth for the connection can be allocated to that connection according to Eq. (1). When the original window size decreases, it means that the TCP destination wants to slow down data transmission for this connection. The present invention decreases the new window size proportionally according to Eq (1) to enable flow control for the TCP connection. Therefore, the means to determine the new window size according to Eq. (1) can achieve high network utilization and efficient flow control in an integrated manner.

### 7) Window Size Modification Module 208

Window size modification module 208 adjusts the window size value 305 in the TCP header for each newly intercepted incoming TCP packet according the calculation result obtained by window size calculation module. After the modification, the module will forward the modified TCP packet to LAN network interface 201 using forwarding module 203B. TCP source 102 will respond to the new window size to achieve high network utilization and efficient flow control in the same time.

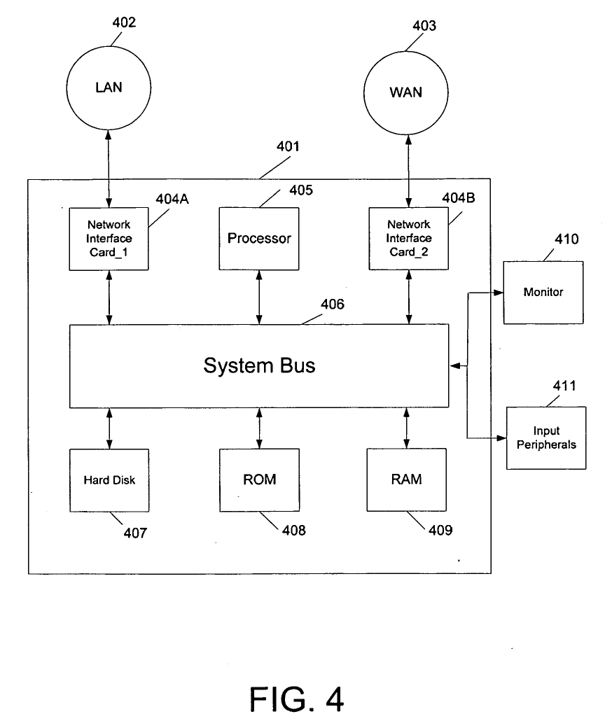

FIG. 4 depicts an implementation of the present invention using a computer system 401 in accordance to the preferred embodiment of the present invention. A typical computer system 401 with two network interfaces (404A and 404B) can be used to implement the present invention. The computer system 401 consists of a processor 405, read only memory (ROM) 408, random access memory (RAM) 409, hard disk 407, network interface card 404A connected to LAN interface 402, network interface card 403 connected to WAN interface 403, and optional peripherals including 410 monitor, input peripherals 411 like mouse and keyboard. The peripherals are optional since the computer system 401 can be controlled remotely over network. The modules shown in FIG. 2 described above can be implemented by instructions which are stored inside hard disk 407 and are loaded into RAM 409 for execution when the computer system 401 is on. The functionalities of these modules can be realized by those instructions for all outgoing and incoming packets. Beside this software implementation of these modules, the present invention also can be implemented using hardware circuits for example, field programmable gate array (FPGA) or application specific integrated circuit (ASIC).

While the invention has been particularly shown and described with reference to a preferred embodiment, the present invention also covers various obvious and equivalent changes within the spirit and scope of the invention.

What are claimed are:

1. A method for network acceleration over networks with long transmission latency utilizing Transport Control Protocol (TCP), said method comprising:
intercepting packets from local hosts and remote hosts and exacting information from their packet headers for classification and measurement of bandwidth usage, round trip time, and number of TCP connections; and
means to calculate a new window size value according to said measurement results including current network bandwidth usage status, RTT for each connections and flow control information from remote hosts and reset the new window size value for each TCP packet received from remote hosts for almost full utilization of available network bandwidth;

2. The method according to claim 1, further comprising traffic classification for packets received from local hosts and remote hosts according to their source and destination IP addresses. All received packets are classified into different private groups and the public group.

3. The method according to claim 1, further comprising means to calculate available bandwidth for each connection within each group, which is proportional to the difference between the allocated bandwidth for each group and measured bandwidth usage for non-TCP traffic in each group.

4. The method according to claim 1, further comprising means to convert the available bandwidth to corresponding window size value using measured RTT for each TCP connection to dynamically achieve high utilization of available network bandwidth under different network status.

5. The method according to claim 1, further comprising means to determine the new window size value by considering flow control information from remote hosts using the original window size for each packet and initial window size value for the TCP connection which the packet belongs to.

6. The method according to claim 1, further comprising means calculate a new window size value to control the sending rate of local hosts to achieve two targets: high utilization of available network bandwidth and flow control in the same time.

7. The method according to claim 1, further comprising means to achieve network acceleration for TCP connections without the need to buffer and cache any received packets.

8. The method according to claim 1, further comprising means to achieve network acceleration for TCP connections without the support of large window option from any local and remote hosts. The method according to claim 1 can work with and without support of large window option for any hosts.

9. A network device for network acceleration over networks with long transmission latency utilizing Transport Control Protocol (TCP), said device comprising:
two network interfaces intercepting and forward packets from local hosts and remote hosts; and
a processor (1) exacting information from their packet headers for classification and measurement of bandwidth usage, round trip time, and number of TCP connections and (2) calculating a new window size value according to said measurement results and flow control information from remote hosts and (3) resetting the new window size value for each TCP packet received from remote hosts;

10. The device according to claim 9, further comprising traffic classification for packets received from local hosts and remote hosts according to their source and destination IP addresses. All received packets are classified into different private groups and the public group.

11. The device according to claim 9, further comprising means to calculate available bandwidth for each connection within each group, which is proportional to the difference between the allocated bandwidth for each group and measured bandwidth usage for non-TCP traffic in each group.

12. The device according to claim 9, further comprising means to convert the available bandwidth to corresponding window size value using measured RTT for each TCP connection to dynamically achieve high utilization of available network bandwidth under different network status.

13. The device according to claim 9, further comprising means to determine the new window size value by considering flow control information from remote hosts using the original window size for each packet and initial window size value for the TCP connection which the packet belongs to.

14. The device according to claim 9, further comprising means calculate a new window size value to control the sending rate of local hosts to achieve two targets: high utilization of available network bandwidth and flow control in the same time.

15. The device according to claim 9, further comprising means to achieve network acceleration for TCP connections without the need to buffer and cache any received packets.

16. The device according to claim 9, further comprising means to achieve network acceleration for TCP connections without the support of large window option from any local and remote hosts. The device according to claim 9 can work with and without support of large window option for any hosts.

17. A data communication system for network acceleration over networks with long transmission latency utilizing Transport Control Protocol (TCP), said device comprising:
a plurality of communication channels for data transmission; and
a gateway (1) exacting information from their packet headers for classification and measurement of bandwidth usage, round trip time, and number of TCP connections and (2) calculating a new window size value according to said measurement results and flow control information from remote hosts and (3) resetting the new window size value for each TCP packet received from remote hosts;

18. The system according to claim 17, further comprising traffic classification for packets received from local hosts and remote hosts according to their source and destination IP addresses. All received packets are classified into different private groups and the public group.

19. The system according to claim 17, further comprising means to calculate available bandwidth for each connection within each group, which is proportional to the difference between the allocated bandwidth for each group and measured bandwidth usage for non-TCP traffic in each group.

20. The system according to claim 17, further comprising means to convert the available bandwidth to corresponding window size value using measured RTT for each TCP connection to dynamically achieve high utilization of available network bandwidth under different network status.

21. The system according to claim 17, further comprising means to determine the new window size value by considering flow control information from remote hosts using the original window size for each packet and initial window size value for the TCP connection which the packet belongs to.

22. The system according to claim 17, further comprising means calculate a new window size value to control the sending rate of local hosts to achieve two targets: high utilization of available network bandwidth and flow control in the same time.

23. The system according to claim 17, further comprising means to achieve network acceleration for TCP connections without the need to buffer and cache any received packets.

24. The system according to claim 17, further comprising means to achieve network acceleration for TCP connections without the support of large window option from any local and remote hosts. The device according to claim 17 can work with and without support of large window option for any hosts.
